(19) United States
(12) Patent Application Publication
(10) Pub. No.: US 2023/0403489 A1
(43) Pub. Date: Dec. 14, 2023

(54) DETACHABLE AMPLIFIER AND SPEAKER MODULE

(71) Applicant: BASSMOTO LLC, Austin, TX (US)

(72) Inventor: Robert Anderson, Austin, TX (US)

(73) Assignee: BASSMOTO LLC, Austin, TX (US)

(21) Appl. No.: 18/333,266

(22) Filed: Jun. 12, 2023

Related U.S. Application Data
(60) Provisional application No. 63/366,311, filed on Jun. 13, 2022.

(51) Int. Cl. H04R 1/02

(52) U.S. Cl. CPC H04R 1/025; H04R 2499/13

(57) ABSTRACT

Apparatus and associated methods relate to a releasably mounted amplifier and speaker module having an impact-resistant hard top and a flexible fabric back. In an illustrative example, a Detachable Amplifier and Speaker Module (DASM) may include one or more speakers coupled to an amplifier. For example, the DASM may be detachably coupled to a seat of a motorcycle. The amplifier, for example, may receive power from the motorcycle to play an audio data stream received wirelessly from a mobile device. For example, the hard top may be durable and scratch-resistant. The fabric back, for example, may be soft (e.g., padded) to adaptably set the DASM on various shape of seats on various motorcycles. Various embodiments may advantageously secure a quick release speaker module to the motorcycle.

### CROSS-REFERENCE TO RELATED APPLICATIONS

This application claims the benefit of U.S. Provisional Application Ser. No. 63/366,311, titled “Detachable Amplifier and Speaker Module,” filed by Robert Anderson, on Jun. 13, 2022.

This application incorporates the entire contents of the foregoing application(s) herein by reference.

### TECHNICAL FIELD

Various embodiments relate generally to speakers.

### BACKGROUND

Speakers are electroacoustic transducers that convert an electrical audio signal into a corresponding sound. A speaker system includes one or more such speaker drivers, an enclosure, and electrical connections. Speakers may, for example, be included in mobile vehicles, such as motorcycles. A motorcycle is a two or three-wheeled motor vehicle steered by a handlebar from a saddle-style seat. Motorcycle design may, for example, vary to suit different purposes such as commuting, long-distance travel, off-road riding, and sport racing. Motorcycling may, for example, include social activities such as motorcycle clubs and motorcycle rallies.

Mobile music may, for example, be downloaded and/or streamed to mobile phones and played by mobile phones and/or smart devices (e.g., tablets, players on demand, smart watches). Music may, for example, be streamed wirelessly, stored onto the memory of the mobile music device, and/or streamed from public radio stations (e.g., AM, FM radio). Music may, for example, be played via wired connections to the mobile device.

Music may, for example, be played without wires via Bluetooth. Bluetooth is a short-range wireless technology standard that is used for exchanging data between fixed and mobile devices over short distances. Bluetooth may be used as an alternative to wire connections, to exchange files between nearby portable devices and connect music players with speakers.

### SUMMARY

Apparatus and associated methods relate to a releasably mounted amplifier and speaker module having an impact-resistant hard top and a flexible fabric back. In an illustrative example, a Detachable Amplifier and Speaker Module (DASM) may include one or more speakers coupled to an amplifier. For example, the DASM may be detachably coupled to a seat of a motorcycle. The amplifier, for example, may receive power from the motorcycle to play an audio data stream received wirelessly from a mobile device. For example, the hard top may be durable and scratch-resistant. The fabric back, for example, may be soft (e.g., padded) to adaptably set the DASM on various shape of seats on various motorcycles. Various embodiments may advantageously secure a quick release speaker module to the motorcycle.

Apparatus and associated methods relate to a portable audio speaker system. In an illustrative example, the portable audio speaker system may, for example, include a upper shell. The upper shell may, for example, be a hard shell. The portable audio speaker system may, for example, include a deformable lower shell. The upper shell and lower shell may, for example, cooperate to define a cavity. The cavity may, for example, include an amplifier. The cavity may, for example, include at least one speaker communicably coupled to the amplifier and mechanically coupled to the upper shell. The cavity may, for example, include at least one coupling member configured to releasably couple the lower shell to a surface. The upper shell may, for example, provide structure sufficient to suspend the at least one speaker, and the lower shell being configured to conform to a shape of the surface when supporting the weight of at least the upper shell, the amplifier, and the at least one speaker.

Various embodiments may achieve one or more advantages. For example, some embodiments may allow user to attach a DASM to motorcycle to play music while riding. The DASM may, for example, be used at social events such as motorcycle rallies. The DASM may, for example, allow a group of cyclists to play music in sync with each other while motorcycling rallying. The DASM may, for example, allow a user to play music from a speaker securely coupled to a motorcycle seat while riding their motorcycle.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary detachable amplifier and speaker Module (DASM) employed in an illustrative use-case scenario.

FIG. 2A is a side view of an exemplary DASM.

FIG. 2B is a side view of an exemplary DASM.

FIG. 3 is a top view of an exemplary DASM.

FIG. 4 is an inner view of a top cover of an exemplary DASM.

FIG. 5 is a block diagram of an exemplary DASM.

FIG. 6A is a perspective view of a loudspeaker shell.

FIG. 6B is a front view of a loudspeaker shell.

FIG. 6C is a back view of a loudspeaker shell.

FIG. 6D is a top view of a loudspeaker shell.

FIG. 6E is a bottom view of a loudspeaker shell.

FIG. 6F is a left side view of a loudspeaker shell.

FIG. 6G is a right side view of a loudspeaker shell.

FIG. 7A is a perspective view of a hard shell loudspeaker casing.

FIG. 7B is a bottom view of a hard shell loudspeaker casing.

FIG. 7C is a top view of a hard shell loudspeaker casing.

FIG. 7D is a back view of a hard shell loudspeaker casing.

FIG. 7E is a front view of a hard shell loud speaker casing.

FIG. 7F is a left side view of a hard shell loud speaker casing.

FIG. 7G is a right side view of a hard shell loud speaker casing.

Like reference symbols in the various drawings indicate like elements.

### DETAILED DESCRIPTION OF ILLUSTRATIVE EMBODIMENTS

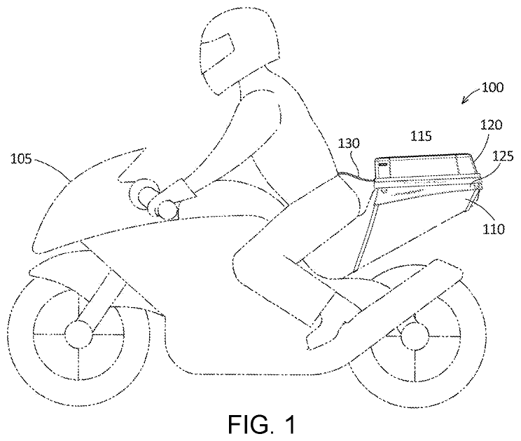

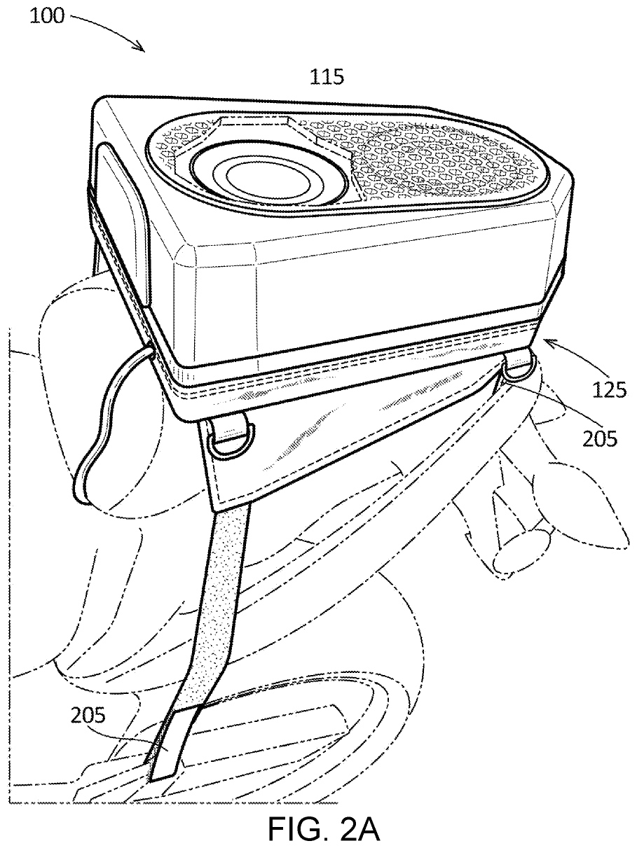

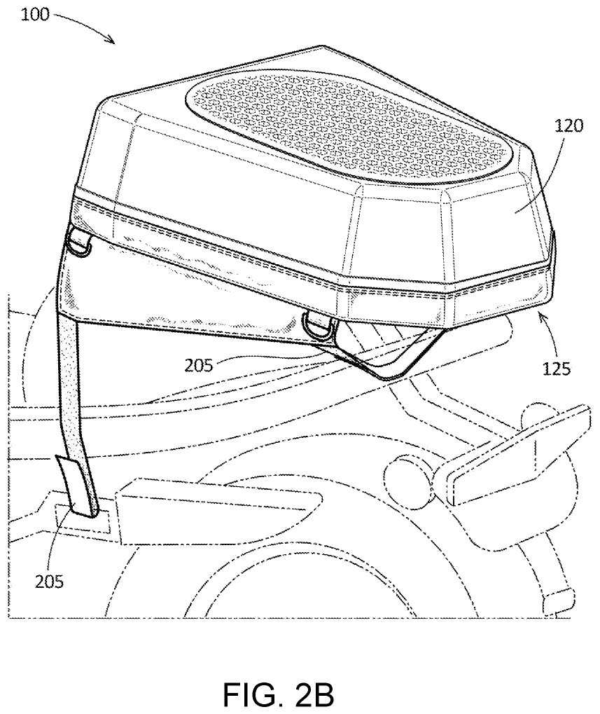

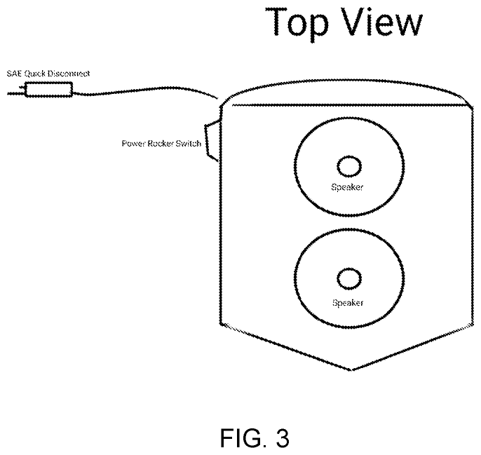

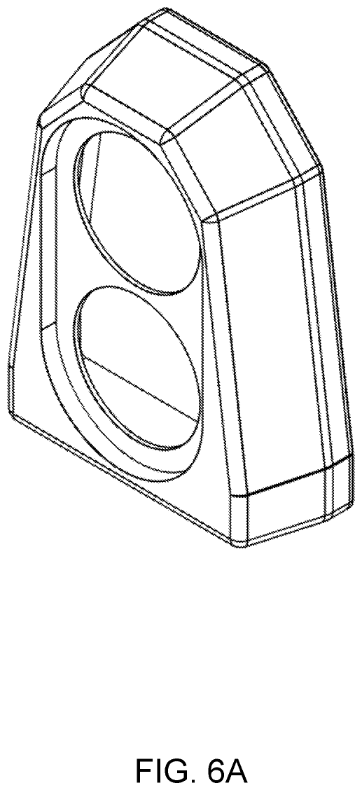

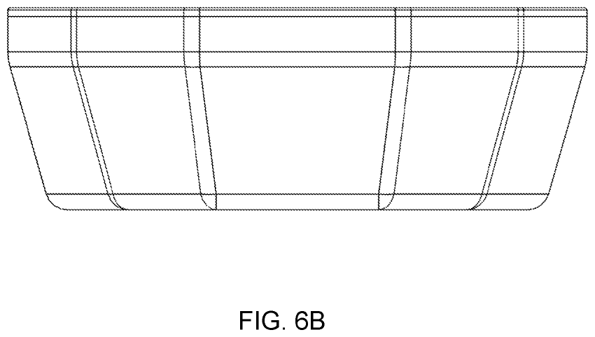

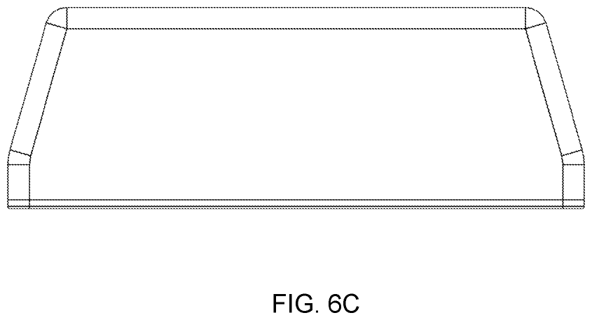

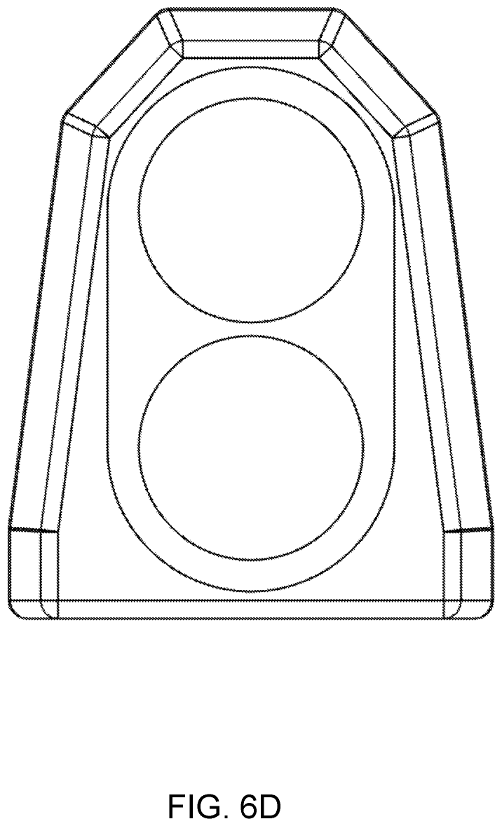

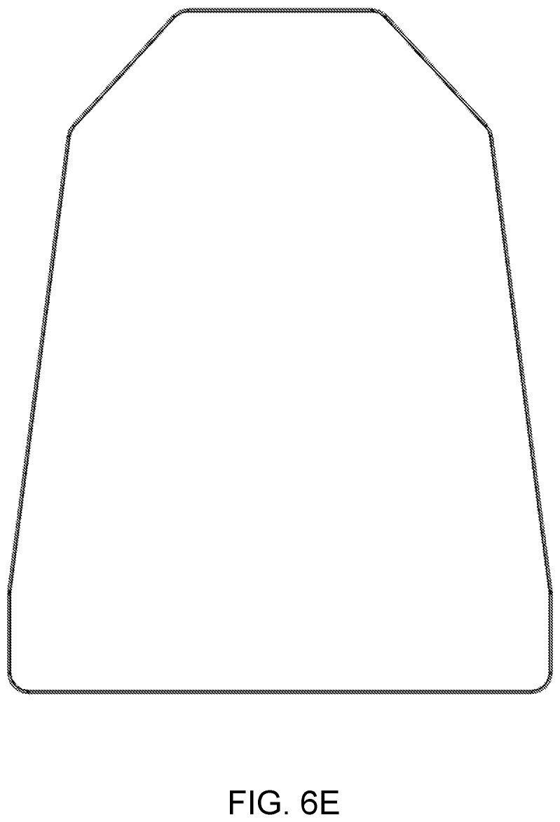

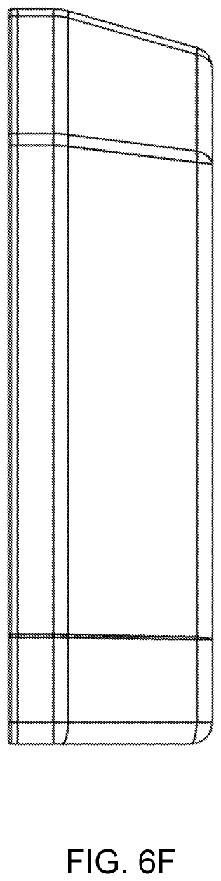

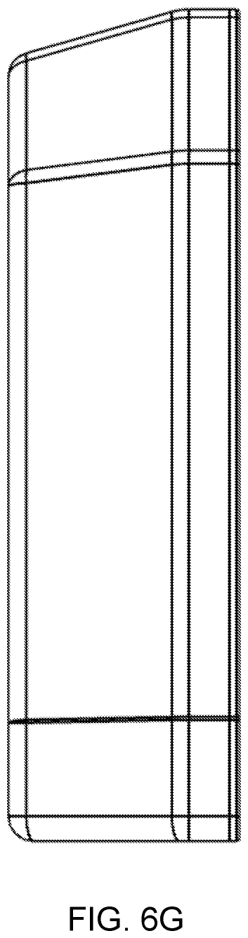

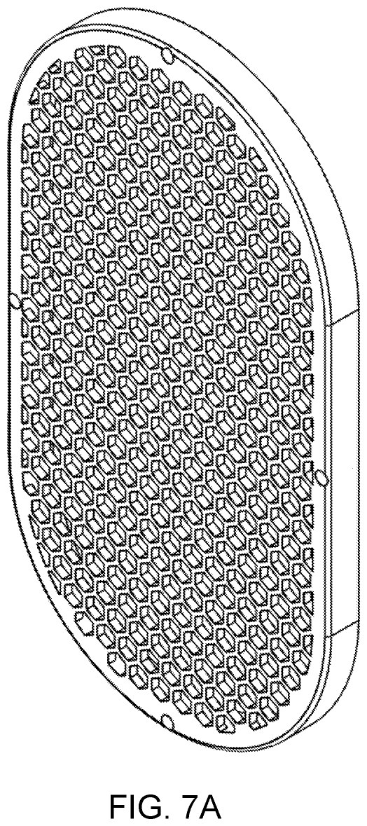

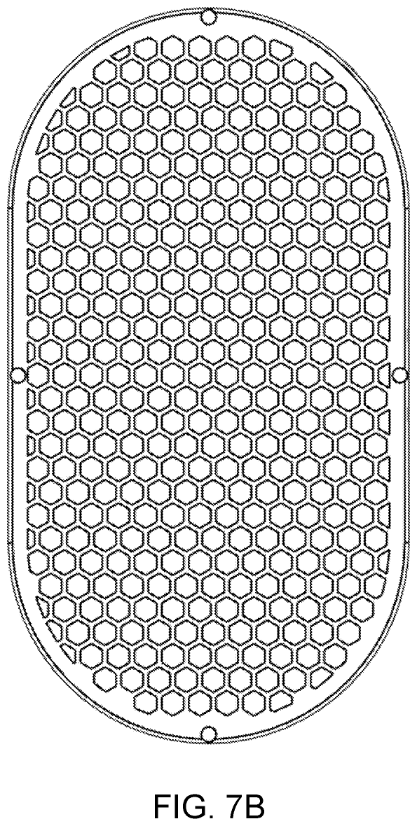

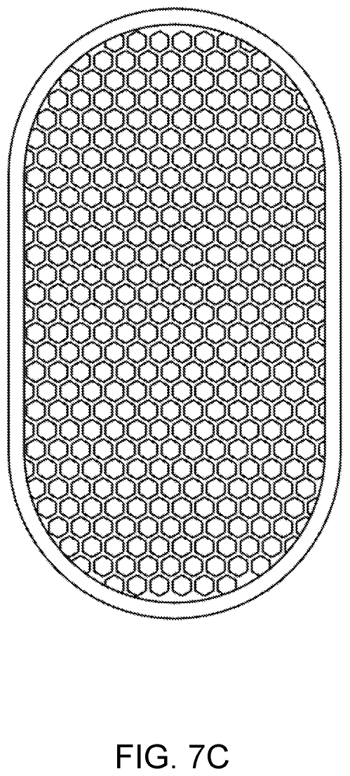

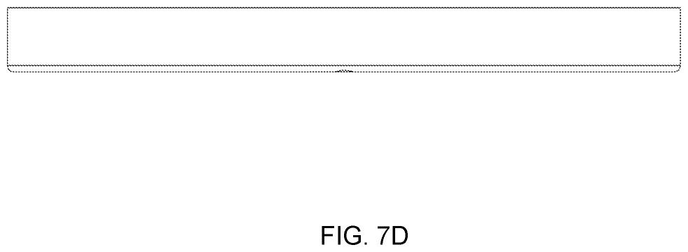

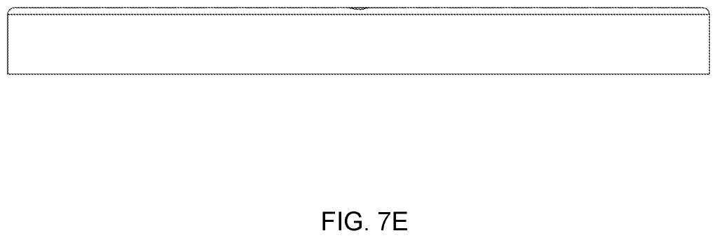

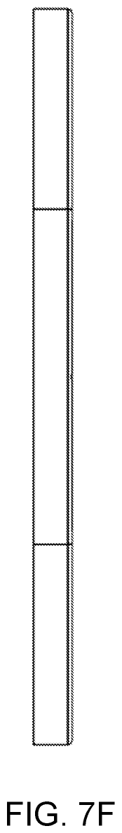

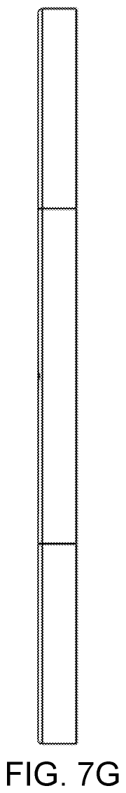

To aid understanding, this document is organized as follows. First, to help introduce discussion of various embodiments, an illustrative detachable amplifier and speaker module (DASM) use case scenario is introduced with reference to FIG. 1. Second, that introduction leads into a description with reference to FIGS. 2A-2B of some exemplary embodiments of an exemplary DASM. Third, with reference to FIGS. 3-5 of some exemplary DASM are described. Fourth, with reference to FIGS. 6A-7G, the discussion turns to exemplary embodiments that illustrate the hard shell and bottom shell.

FIG. 1 depicts an exemplary Detachable Amplifier and Speaker Module (DASM 100) employed in an illustrative use-case scenario. The DASM 100 is, in this example, releasably mounted on a motorcycle 105. For example, the DASM 100 may be mounted on the motorcycle 105 with a coupling mechanism that may, for example, include Velcro tapes, tie down loops (e.g., rubber bungee), Loops and strap configuration (e.g. D-Ring, carabiner configurations), and/or other mounting devices. In some examples, the mounting devices may securely fasten the DASM 100 to a seat 110 so that the DASM 100 may not fall off during a motion of the motorcycle 105.

The DASM 100 includes two speakers 115 in this example. For example, the speakers 115 may be waterproof. In some implementations, the speakers 115 may be fixedly coupled to the DASM 100. In some examples, the DASM 100 may include other number of speakers (e.g., 1, 3, 4, 5). In some implementations, the speakers 115 may be connected to a user device wirelessly (e.g., via Bluetooth). For example, the user device may play music at the speakers 115 by transmitting an audio data stream (e.g., music) to the DASM 100. For example, the DASM 100 may include a waterproof amplifier (not shown) to power the speakers 115 to play music.

The DASM 100 includes a hard shell 120 fixedly coupled to a soft fabric back 125. For example, the hard shell 120 and the soft fabric back 125 may be fixedly coupled (e.g., sewn) together. The hard shell 120, for example, may be a scratch-resistant or impact-resistant hard plastic (e.g., Polycarbonate, Acrylonitrile butadiene styrene). For example, the hard shell 120 may advantageously support a weight of the speakers 115. In some examples, the soft fabric back 125 may include padding. In some implementations, the soft fabric back 125 may allow the DASM 100 to advantageously be adaptable to different shapes of the seat 110. For example, the soft fabric back 125 may advantageously conform at least partially around an upper shape of the seat 110, thereby increasing resistance to sliding of the DASM 100 relative to the seat 110.

As shown in FIG. 1, the DASM 100 includes a power input 130. For example, the power input 130 may be a detachable lead coupled to a motorcycle battery. In some implementations, the power input may include a quick disconnection connector (e.g., a SAE plug) to advantageously allow quick mount/dismount of the DASM 100.

FIGS. 2A-2B are perspective view of an exemplary DASM 100 as describe with reference to FIG. 1. As shown, the DASM 100 includes two hook-and-loop mount 205 for mounting on a seat or a luggage box of a motorcycle. The DASM 100 further includes a switch wheel 210. For example, a user may easily reach and operate the switch wheel 210 to switch on/off or adjust the volume of the speakers 115. In some implementations, the switch wheel 210 may advantageously be located on a left-hand side of the DASM 100 to facilitate operating of the DASM 100.

In some implementations, the hard shell 120 may include preformed cutout (e.g., drilled, formed during molding) to accommodate the speakers 115. The hard shell 120 and the speakers 115 may, in some examples, be fused together. As shown in this example, some portion of the speakers 115 are exposed on top of the hard shell 120. In some examples, the speakers 115 may be entirely hidden under the hard shell 120. For example, the speakers 115 may include a speaker mesh over the top.

The fabric back 125, in some implementations, may include a padded (e.g., slightly padded) nylon canvas fabric (e.g., 250-500 gsm). For example, the fabric back 125 may include ¼ inch foam of padding. The fabric back 125 may, for example, include less than ¼ inch of foam padding. The fabric back 125 may, for example, in a ‘plush’ embodiment, include more than ¼ inch of foam padding In some examples, the padding may advantageously contour the DASM 100 to adapt a shape of a motorcycle seat (e.g., the seat 110).

In some implementations, at least one shelf and/or at least one inner shell may be provided within the hard shell 120. For example, the speakers and/or amplifier may be mounted to an inner shelf and/or shell. The inner shelf and/or shell may, for example, be coupled to the hard shell 120. Such implementations may, for example, advantageously provide interior structure, protection, and/or support within the DASM 100.

FIG. 3 is a top view of an exemplary DASM. The exemplary DASM includes a SAE quick disconnect. The SAE quick disconnect may, for example, be designed for cable extension for a battery charger and/or devices for power. The exemplary DASM includes a power rocket switch. The power rocket switch may, for example, be used to start and/or stop the flow of current in the circuit with a push on either side of the switch. The rocker switch may, for example, include a general toggle or trip switch. The rocker switch may, for example, stay put in a tilt position until changed or pushed with an external force. In some implementations, a toggle switch may, for example, be used to replace the power rocker switch.

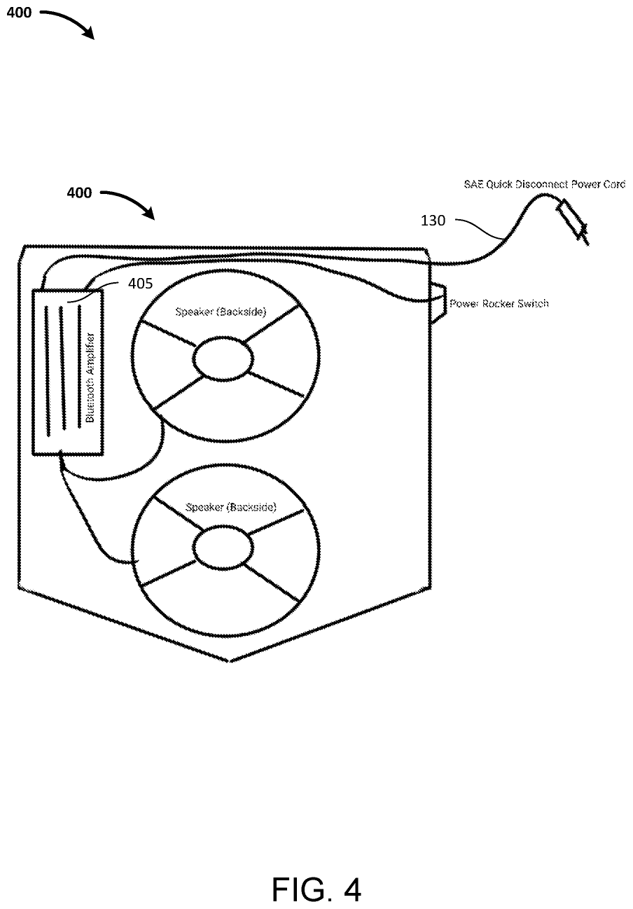

FIG. 4 is an inner view of a top cover 400 of an exemplary DASM. As shown in this example, an amplifier 405 is attached to the top cover 400. For example, the amplifier 405 may be remotely controlled by a wireless control application (e.g., an app in a mobile device). In some implementations, the amplifier 405 may be coupled (e.g., wired or wirelessly) to a remote control mountable on a handlebar of the motorcycle 105. For example, control signals may be transmitted to the amplifier 405 via the power input 130.

In some implementations, the top cover 400 may include additional supports extended form the inner surface to support a weight of the amplifier 405. For example, the additional supports may advantageously increase a range of amplification power for the speakers 115. In some implementations, a battery may, for example, be used internally to power the DASM. The battery may, for example, be rechargeable. The battery may, for example, be changed via the SAE quick disconnect power cord. The battery may, for example, be powered via other cables transferring power depending on the electrical configuration of the DASM.

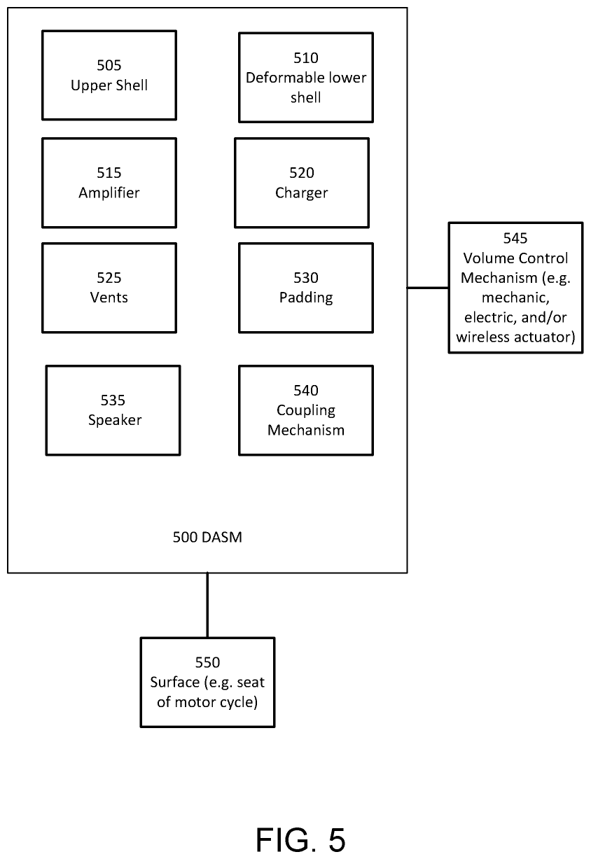

FIG. 5 is a block diagram of an exemplary DASM 500. As shown in this example, the DASM 500 includes an upper shell 505. The upper shell may, for example, be fenestrated. The fenestrations may, for example, advantageously provide apertures for the speakers to convey music through. The fenestrations may, for example, include a visual pattern. For example, as depicted, the fenestrations may be patterned as a honeycomb.

The exemplary DASM 500 includes a deformable lower shell 510. The deformable lower shell may, for example, include a solid frame. The deformable lower shell may, for example, be deformable such that the bottom of the lower shell conforms to the shape of a seat. The exemplary DASM 500 includes an amplifier 515. The exemplary DASM 500 includes a charger 520. The exemplary DASM includes vents 525. The vents may, for example, facilitate air flow in the DASM. In some implementations, the DASM 500 may include a fan to blow hot air out of the DASM 500 and to advantageously maintain a predetermined range of operation temperature within the DASM 500. In some implementations. the vents may, for example, in a mobile mode, wherein the DASM is attached to an externally to vehicle such as a motorcycle, may direct air flow externally to cool the DASM.

The exemplary DASM 500 includes padding 530. The padding may, for example, be coupled to the deformable lower shell. The padding may, for example, be placed externally along the upper shell and deformable lower shell. The padding may, for example, allow the deformable lower shell to deform to the seat. The padding may, for example, be used to prevent discomfort conditions to a user leaning against the upper shell while riding a motor cycle. The padding may, for example, prevent numbness and rubbing on sensitive areas such as the back of a user.

The exemplary DASM 500 includes speakers 535. The exemplary DASM 500 includes a coupling mechanism 540. The coupling mechanism 540 may, for example but not in limitation, include D-ring and straps; a magnet coupler buckle; Velcro; buckles; and/or hook/rings. The coupling mechanism 540 may, for example, be used to couple the deformable lower shell 510 to a surface 550. The surface may, for example, include the seat of the motorcycle.

In some implementations, a volume control mechanism 545 may, for example, be coupled to the DASM 500. The volume control mechanism may, for example, be mechanical (i.e. use a mechanical device to change the resistance, such as e.g. an potentiometer with terminal resistors). The volume control mechanism may, for example, be electrical using a control system to alter resistance to control the volume of the device. The volume control mechanism may, for example, be controlled wirelessly. The volume control mechanism may, for example, receive input from a secondary device to control volume. The volume control mechanism may, for example, receive an input from a smart phone device. The volume control mechanism may, for example, receive an input from a processor within the motorcycle. The volume control mechanism may, for example, receive an input from a device attached to the motorcycle.

FIGS. 6A-6G shows views of an exemplary DASM deformable lower shell. FIGS. 7A-7G show views of an exemplary DASM upper shell. in an exemplary embodiment.

In some implementations, the hard shell 120 may have a decorative textured surface.

In some implementations, the DASM 100 may, for example, includes a zipper for access a padding compartment. For example, a user may add or remove padding materials from the padding compartment to adjust a size and flexibility of the fabric back 125.

In some implementations, the hard shell 120 may be fixedly (e.g., permanently) coupled to the fabric back 125. For example, the hard shell 120 may be stitched directly to the fabric back 125. Such embodiments may, for example, advantageously provide a robust shell capable of protecting and/or supporting the speaker(s) and electronic components within a non-storage area. In some implementations, by way of example and not limitation, the DASM 100 may have no storage compartment accessible by a user. Such implementations may, for example, advantageously protect the speaker(s) and electronic components from inadvertent damage by user inserted gear.

In some implementations, the DASM may include a reflective surface (e.g., a reflective patch) at a front side, facing a backside of the motorcycle 105 when mounted. For example, the reflective surface may be decorative and also improve safety of a rider of the motorcycle.

Although various embodiments have been described with reference to the figures, other embodiments are possible. For example, the DASM 100 may include an auxiliary input port (e.g., to receive a 3.5 mm Stereo cable) to receive audio data stream.

In some implementations, the DASM 100 may include a lithium battery so that power from the motorcycle 105 is not required. In some examples, the DASM 100 may include a USB port for recharging the lithium battery.

In some implementations, the DASM 100 may include interchangeable hard shells (e.g., faceplates). For example, a user may swap design and/or colors of the hard shell.

Although an exemplary system has been described with reference to FIG. 1, other implementations may be deployed in other industrial, scientific, medical, commercial, and/or residential applications. For example, the DASM 100 may be mounted to e-bikes and/or scooters. In some examples, the DASM 100 may be used in an all-terrain vehicle. In some examples, the DASM 100 may be used in a boat. In some implementations, the DASM may, for example, be configured to work in conjunction with other DASMs to play in sync with one another. The DASM may, for example, be used at social events such as motor cycle rallies to play songs in conjunction with each other in sync.

The amplifier may, for example, be electronically coupled to a power cord.

The portable audio speaker system may, for example, be configured to conform to a surface such as, for example, a seat of a motorcycle.

The portable audio speaker system may, for example, receive power from the motorcycle.

An at least one speaker may, for example, be wirelessly coupled to a secondary device that includes audio files.

The deformable lower shell may, for example, include a fabric back such that the fabric back may deform to different motorcycle seat structures.

An upper shell may, for example, include a set of geometric apertures through a front and back of the upper shell. The apertures of the upper shell may, for example, include geometric shapes (e.g., circles, triangles, squares, rectangles, rhombuses, multi-sided shapes, irregular shapes, shape combinations, shape combinations spread across different layers). The apertures may, for example, be honeycombed shaped.

The upper shell and the deformable lower shell may, for example, be water resistant.

The at least one speaker may, for example, be coupled to the amplifier that may, for example, electrically coupled to a battery. The at least one speaker may, for example, be coupled to the amplifier that may, for example, be electrically coupled to a rechargeable lithium-ion battery.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A portable audio speaker system, comprising:
an upper shell configured with a set of geometric apertures through a front and back of the upper shell; and,
a deformable lower shell cooperating to define a cavity;
an amplifier disposed in the cavity and electronically coupled to a power cord;
at least one speaker disposed in the cavity and communicably coupled to the amplifier and mechanically coupled to the upper shell; and,
at least one coupling member configured to releasably couple the lower shell to a surface,
wherein, the upper shell provides structure sufficient to suspend the at least one speaker, and the lower shell is configured to conform to a shape of the surface when supporting the weight of at least the upper shell, the amplifier, and the at least one speaker.

2. The portable audio speaker system of claim 1, wherein the surface includes a seat of a motorcycle.

3. The portable audio speaker system of claim 2, wherein the portable audio speaker system receives power from the motorcycle.

4. The portable audio speaker system of claim 3, wherein the at least one speaker is wirelessly coupled to a secondary device that includes audio files.

5. The portable audio speaker system of claim 2, wherein the deformable lower shell further comprises a fabric back such that the fabric back may deform to different motorcycle seat structures.

6. The portable audio speaker system of claim 1, wherein the apertures of the upper shell further are honeycombed shaped.

7. The portable audio speaker system of claim 1, wherein the upper shell and the deformable lower shell are water resistant.

8. The portable audio speaker system of claim 1, wherein the at least one speaker coupled to the amplifier is electrically coupled to a battery.

9. The portable audio speaker system of claim 8, wherein the at least one speaker coupled to the amplifier is electrically coupled to a rechargeable lithium-ion battery.

10. A portable audio speaker system, comprising:
an upper shell;
a deformable lower shell cooperating with the upper shell to define a cavity;
an amplifier disposed in the cavity;
at least one speaker disposed in the cavity and communicably coupled to the amplifier and mechanically coupled to the upper shell; and
at least one coupling member configured to releasably couple the lower shell to a surface,
wherein, the upper shell provides structure sufficient to suspend the at least one speaker, and the lower shell being configured to conform to a shape of the surface when supporting the weight of at least the upper shell, the amplifier, and the at least one speaker.

11. The portable audio speaker system of claim 10, wherein the upper shell further comprises a set of geometric apertures through a front and back of the upper shell.

12. The portable audio speaker system of claim 10, wherein the amplifier is electronically coupled to a power cord.

13. The portable audio speaker system of claim 10, wherein the surface includes a seat of a motorcycle.

14. The portable audio speaker system of claim 13, wherein the portable audio speaker system receives power from the motorcycle.

15. The portable audio speaker system of claim 14, wherein the at least one speaker is wirelessly coupled to a secondary device that includes audio files.

16. The portable audio speaker system of claim 13, wherein the deformable lower shell further comprises a fabric back such that the fabric back may deform to different motorcycle seat structures.

17. The portable audio speaker system of claim 10, wherein the apertures of the upper shell further are honeycombed shaped.

18. The portable audio speaker system of claim 10, wherein the upper shell and the deformable lower shell are water resistant.

19. The portable audio speaker system of claim 10, wherein the at least one speaker coupled to the amplifier is electrically coupled to a battery.

20. The portable audio speaker system of claim 10, wherein the amplifier is mechanically coupled to and suspended by the upper shell.
